(19) United States
(12) Patent Application Publication
(10) Pub. No.: US 2026/0051934 A1
(43) Pub. Date: Feb. 19, 2026

(54) DEEP LEARNING FOR SCALABLE TRANSMISSION BEAMFORMING WITH COMPRESSED CHANNEL REPRESENTATION

(71) Applicant: Cypress Semiconductor Corporation, San Jose, CA (US)

(72) Inventors: Avik Santra, Irvine, CA (US); Kiran Uln, Pleasanton, CA (US); Rakesh Taori, McKinney, TX (US)

(73) Assignee: Cypress Semiconductor Corporation, San Jose, CA (US)

(21) Appl. No.: 18/809,145

(22) Filed: Aug. 19, 2024

(51) Int. Cl. H04B 7/06; H04W 24/02

(52) U.S. Cl. CPC H04B 7/0626; H04W 24/02

(57) ABSTRACT

A wireless device includes one or more receive antennas, a processing device coupled to the one or more receive antennas, and memory storing instructions, which when executed by the processing device, cause the processing device to perform operations. In embodiments, these operations include generating, in response to a null data packet received from an anchor wireless device, channel state information (CSI) data to estimate a wireless channel and processing the CSI data using an encoder neural network to generate a latent vector of compressed CSI data. The operations further include transmitting, via a coupled transmit antenna, a packet containing the latent vector to the anchor wireless device for use in determining beamforming to communicate with the wireless device and detect changes in the wireless channel.

### TECHNICAL FIELD

This disclosure relates to wireless devices and, more specifically, to deep learning for scalable transmission beamforming with compressed channel representation.

### BACKGROUND

In current wireless systems (e.g., technology employing IEEE 802.11ac and 802.11ax protocol standards), the state-of-the-art for channel state information (CSI) feedback for transmission (Tx) beamforming utilizes a compressed version of the CS) matrix obtained through eigenvalue decomposition (EVD). At a given time, there are several active wireless client devices or stations (STAs) from which an access point device (AP) requests CSI feedback to perform Tx beamforming, so as to maximize signal reception at a specific STA while minimizing reception at other STAs. The CSI data across antennas and subcarriers intrinsically captures information like signal attenuation, phase shift, and fading experienced by a radio-frequency (RF) signal as it goes from the AP to the STA. In the context of CSI feedback, EVD is applied to the CSI matrix obtained at the receiver, which captures the spatial characteristics of the channel.

To minimize feedback overhead and limiting air-time requirements, wireless (e.g., Wi-Fi®) protocol standards like IEEE 802.11ac and 802.11ax utilize a compressed version of the CSI matrix for feedback, which is based on the right singular matrix (or V matrix) obtained from the EVD of the CSI matrix. For example, the V matrix captures the dominant spatial modes of the channel, which are used for effective beamforming. At the AP, the received V matrix from all active STAs can be used to construct beamforming vectors that focus the transmitted signal towards a specific STA, thereby maximizing a signal-to-noise ratio (SNR), signal quality, range, throughput, and/or data rates with that specific STA.

### BRIEF DESCRIPTION OF THE DRAWINGS

FIG. 1 is a block diagram of a wireless network that includes an example station wireless device (STA) that employs an encoder neural network to compress CSI data as latent vectors, according to various embodiments.

FIG. 2A is a flow chart of a method for the STA processing CSI data with a encoder neural network and transmitting resultant latent vectors to an anchor wireless device according to at least one embodiment.

FIG. 2B is a flow chart of an extension of the method of FIG. 2A in which the STA also predicts, using a long short-term memory (LSTM) network, variations in latent vectors over time according to some embodiments.

FIG. 3 is a block diagram of a wireless network that includes an example anchor wireless device that performs deep learning, using the latent vectors, for scalable transmission beamforming with compressed channel representation according to various embodiments.

FIG. 4A is a flow chart of a method for the anchor wireless device employing a neural network to combine latent vectors into an beamforming weight vector according to some embodiments.

FIG. 4B is a flow chart of the method of FIG. 4A in which the anchor wireless device also predicts, using a LSTM network for each STA, variations in the latent vectors over time according to some embodiments.

FIG. 5 is a flow chart of a method for the anchor wireless device directing a targeted feedback request to the STAs to request particular latent vectors in order to update the beamforming weight vector being used according to some embodiments.

FIG. 6A is a flow chart of a method for a STA handling of the targeted feedback request according to at least one embodiment.

FIG. 6B is a flow chart of a method for a STA handling of the targeted feedback request according to at least another embodiment.

FIG. 7 is an example wireless device that can represent any of the anchor wireless devices or station wireless devices (STAs) capable of performing the operations discussed herein according to embodiments.

### DETAILED DESCRIPTION

The following description sets forth numerous specific details such as examples of specific systems, devices, components, methods, and so forth, in order to provide a good understanding of various embodiments of deep learning for scalable transmission beamforming with compressed channel representation. Further to the above discussion, wireless engineers seek to strike a balance between the compression ratio of the V matrix and the resulting accuracy of the beamforming vectors. High compression can lead to performance degradation, which reduces SNR and generates higher interference. In complex environments with large multi-input, multi-output (MIMO) STAs, the airtime or compressed CSI feedback is typically large, leading to lower effective throughput.

Transmission (Tx) beamforming relies on the assumption of channel reciprocity, where the uplink and downlink channels between an anchor wireless device and a STA are similar. However, this might not always hold true, leading to performance issues. Further, due to CSI feedback latency while the channel changing dynamically, the true CSI may be different from the CSI feedback received from the STA. Further, multi-user MIMO and high quadrature amplitude modulation (QAM) situations demand high accuracy. As result, in some cases, the high compression workloads associated with the V matrix can easily degrade performance to a level that significantly impacts the accuracy of beamforming vectors. If the accuracy of the beamforming vectors is reduced, quality of service in network connectivity by STAs being serviced by the anchor wireless device is also reduced.

To resolve these and other deficiencies with known approaches to an anchor wireless device (such as an AP) using CSI data to generate beamforming vectors, the present disclosure includes a deep learning-based approach of Tx beamforming that leverages several techniques to achieve significant reductions in CSI feedback overhead and improve beamforming efficiency, particularly for future systems with complex channel dynamics. These techniques, which employ neural network learning and variation tracking, can be variably performed at the STA and/or at the anchor wireless device, as will be described.

In some embodiments, for example, the STA generates, in response to a null data packet received from an anchor wireless device, CSI data to estimate a wireless channel. The STA can then process the CSI data using an encoder neural network to generate a latent vector of compressed CSI data. For example, the latent representation of the latent vector contains compressed feature sets of the CSI data, e.g., by reducing its dimensionality. The STA can then transmit, via a coupled transmit antenna, a packet containing the latent vector to the anchor wireless device for use in determining beamforming to communicate with the wireless device and detect changes in the wireless channel. In some embodiments, the STA also predicts, using a long short-term memory (LSTM) network, variations in the latent vectors over time. The STA can then, in response to future CSI requests, transmit a feedback packet to the anchor wireless device with latent vector updates that depend on the amount of CSI-based changes, as determined by the LSTM network. For example, the feedback packet could include no change, a compressed representation of the change (e.g., as a delta latent vector), or a full latent vector that completely characterizes CSI of the wireless channel.

In some embodiments, furthermore, the anchor wireless device receives packets from a plurality of STAs containing a latent vector of compressed CSI data for each respective STA. The anchor wireless device can then provide, to a neural network, the latent vectors for the plurality of STAs. The anchor wireless device can also receive, from the neural network, a beamforming weight vector based on a combination of the latent vectors from the plurality of STAs. In embodiments, the beamforming weight vector is associated with a particular STA of the plurality of STAs. The anchor wireless device can further deploy a spatial mapping, using the beamforming weight vector, when transmitting data to the particular STA using the one or more transmit antennas. In this way, there can be a direct mapping from latent CSI latent representations to a beamforming weight vector for each respective STA.

In further embodiments, the anchor wireless device predicts, by training a LSTM network for each STA, variations in the latent vectors received from each STA over time. The anchor wireless device can further update, based on the variations, the compressed CSI data of the latent vectors and provide the updated latent vectors to the neural network to generate an updated beamforming weight vector for use in the spatial mapping. In this way, the anchor wireless device can itself track variations in the compressed CSI data and make updates to buffered latent vectors based on an amount of the variations.

The present disclosure includes a number of advantages, including the ability to directly map latent CSI representations to beamforming weight vectors, and thus skip past a significant amount of processing, which reduces feedback overhead. For example, instead of decoding the latent representation back into the tradition V matrix, the anchor wireless device can utilize the latent vectors from all the active STAs to map to the corresponding beamforming weight vector for each individual STA. This enables eliminating the need for a separate decoding and beamforming mapping stages, simplifying the process of generating beamforming and improving efficiency. Further, the LSTM networks at both the STAs and anchor wireless device enables efficiently tracking of channel variations, thus obviating the need to always transmit and process full compressed CSI data for the wireless channel. So, for example, the CSI feedback can be based on channel dynamics, minimizing overhead in static CSI scenarios. Additional advantages will be apparent to those skilled in the art of Tx beamforming, as discussed further below.

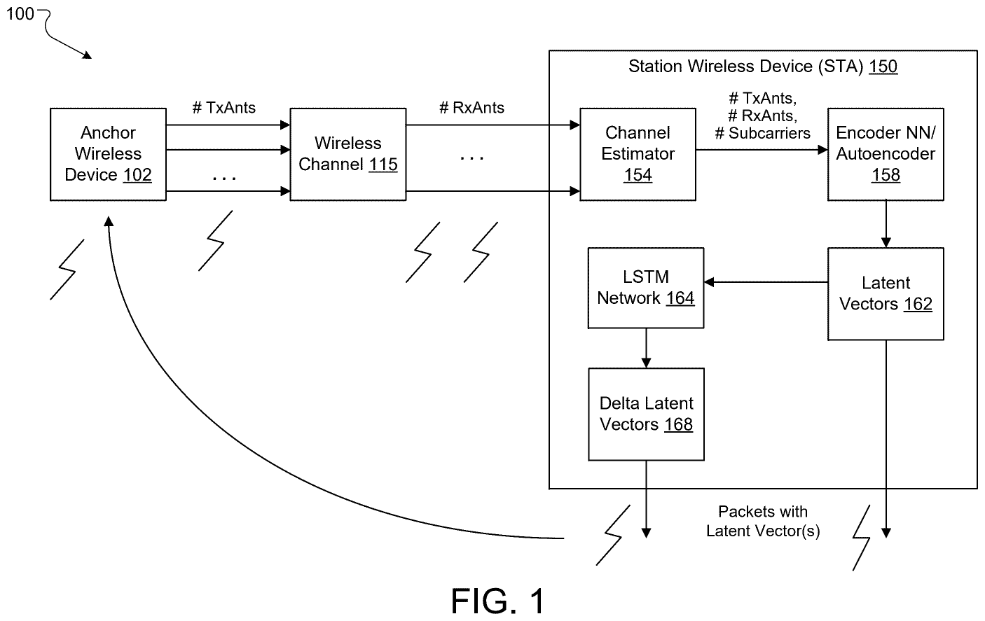

FIG. 1 is a block diagram of a wireless network 100 that includes an example station wireless device (STA) 150 that employs an encoder neural network to compress CSI data as latent vectors, according to various embodiments. For example, the wireless network 100 can include, but not be limited to, an anchor wireless device 102, which communicates over a wireless channel 115 with the STA 150. The anchor wireless device 102 could be a router, AP, hub, or the like that provides network (and/or Internet) connectivity to client wireless devices such as the STAs discussed herein. In embodiments, the CSI data associated with the wireless channel 115 includes the number of transmission antennas at the anchor wireless device 102 and the number of receive antennas at the STA 150. In at least some embodiments, the STA 150 is representative of all the STAs referred to herein, and can include a channel estimator 154, a encoder neural network 158 (or autoencoder), latent vectors 162 generated by the encoder 158 (or autoencoder), an LSTM network 164, and delta latent vectors 168 generated by the LSTM network 164.

In some embodiments, the channel estimator 154 estimates the CSI of the wireless channel 115 to generate CSI data. This CSI data can include information such as signal attenuation, phase shift, and fading experienced by an RF signal passing through the wireless channel 115, in particular from the anchor wireless device 102 to the STA 150. In embodiments, the dimensionality of the CSI data includes a number of subcarriers of the wireless channel 115, a number of transmit antennas of the anchor wireless device 102, and a number of one or more receive antennas of the STA 150, e.g., which can be expressed as (#Subcarriers, #TxAnts, #RxAnts).

In at least some embodiments, the STA 150 feeds a multidimensional tensor to the encoder neural network 158. In embodiments, the multidimensional tensor, e.g., (#Subcarriers, #TxAnts, #RxAnts) represents the CSI information across both frequency subcarriers and number of antennas. This multi-dimensional format allows the encoder neural network 158 to exploit spatial and spectral correlations within the CSI channel data. In embodiments, the encoder neural network 158 compresses the multi-dimensional CSI data into a lower-dimensional latent representation, capturing CSI characteristics (or features) to be used for the beamforming while reducing transmission overhead. Further, real and imaginary data for subcarriers channels can pass through the encoder neural network 158, which enables compression to occur across subcarrier domains.

In some embodiments, the encoder neural network 158 is an autoencoder with LSTM network integration, e.g., of the LSTM network 164. For example, an autoencoder is a type of neural network used for unsupervised learning of efficient codings. The aim of an autoencoder is to learn a compressed representation (e.g., encoding) for a set of data, typically for the purpose of dimensionality reduction or feature learning. For example, an encoder portion of the autoencoder can compress the input CSI data into a latent space representation, generally referred to herein as latent vectors. The encoder can include one or more layers that reduce the dimensionality of the input data. The output of the encoder is a compact representation, often referred to as the bottleneck or code. A decoder portion of the autoencoder can reconstruct the input data from the compact representation. The decoder can include layers that increase the dimensionality of the code back to the original input size. The autoencoder works toward the output being as close to the original input as possible. The autoencoder can be trained to minimize the reconstruction error, which is the difference between the input data and the reconstructed data.

The LSTM network 164 is employed to analyze the latent representation, e.g., latent vectors 162 obtained from the encoder neural network 158. For example, LSTM networks are a type of recurrent neural network (RNN) that can learn long-term dependencies and are particularly effective at handling sequential data. LSTMs can include a series of cells, each containing a cell state and three gates (input gate, forget gate, and output gate) that regulate the flow of information. These gates can control the addition or removal of information to the cell state, allowing the LSTM network to retain information over long sequences. The input gate can determines how much of the new input should be added to the cell state. The forget gate can determine how much of the existing cell state should be retained. The output gate can determine how much of the cell state should be output at each time step. In embodiments, LSTM networks are trained to minimize a loss function, typically through backpropagation through time (BPTT), which adjusts the weights of the gates to learn the sequence patterns.

In this way, the LSTM network 164 can learn temporal patterns in the channel variations from past observations. Based on the analysis, the STA 150 can transmit a feedback signal to the anchor wireless device 102 indicating the estimated channel variation. The channel variation can be transmitted in at least three different varieties. For example, if the LSTM network 164 predicts minimal change in the CSI data compared to the previous state, the STA 150 can transmit a “no change” indicator to the anchor wireless device. Further, if the LSTM network 164 detects a moderate variation in CSI data compared to the previous state, the STA 150 can generate feedback that includes a compressed representation of the change (e.g., a delta latent vector). Finally, if the LSTM network 164 detects a significant variation between measured CSI data and the previous state, the STA 150 can generate feedback that includes the entire compressed latent representation of the CSI data, e.g., a full latent vector such as output by the encoder neural network 158 (or autoencoder). The STA 150 can transmit a feedback packet with the indicator, the delta latent vector, or the full latent vector, as appropriate, to the anchor wireless device 102.

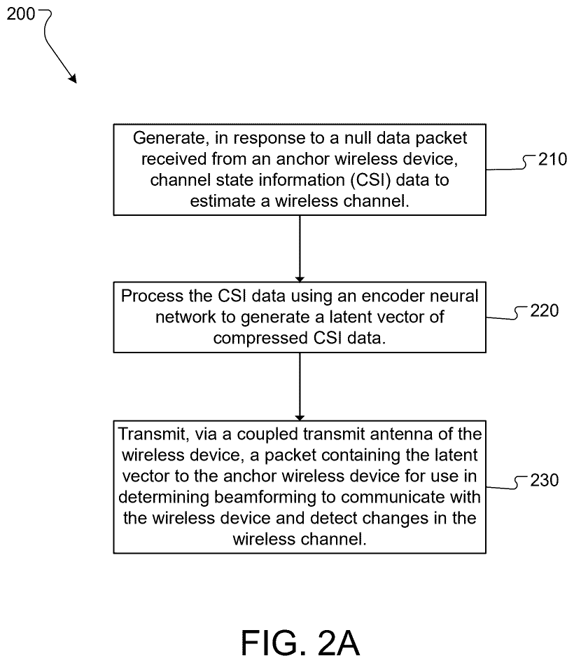

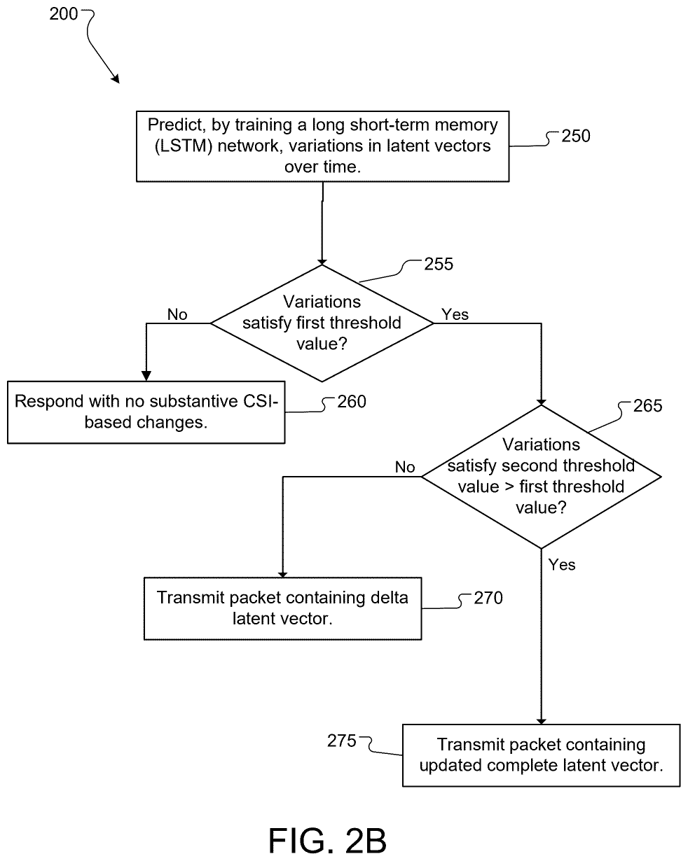

In some embodiments, as referenced in FIG. 2B, detecting the moderate variation includes determining that the variation satisfies a first threshold value. Further, in varying embodiments, detecting the significant variation includes determining that the variation satisfies a second threshold value that is greater than the first threshold value. The term “satisfying” can be understood as being at least equal to or greater than the compared value.

FIG. 2A is a flow chart of a method 200 for the STA processing CSI data with a encoder neural network and transmitting resultant latent vectors to an anchor wireless device according to at least one embodiment. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the STA 150 for example. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, the processing logic generates, in response to a null data packet received from an anchor wireless device, channel state information (CSI) data to estimate a wireless channel.

At operation 220, the processing logic processes the CSI data using the encoder neural network 158 to generate a latent vector of compressed CSI data.

At operation 230, the processing logic transmits, via a coupled transmit antenna, a packet containing the latent vector to the anchor wireless device 102 for use in determining beamforming to communicate with the wireless device and detect changes in the wireless channel.

FIG. 2B is a flow chart of an extension of the method 200 of FIG. 2A in which the STA 150 also predicts, using a long short-term memory (LSTM) network, variations in latent vectors over time according to some embodiments. At operation 250, the processing logic predicts, by training the LSTM network 164, variations in latent vectors over time.

At operation 255, the processing logic determines whether variations in the latent vectors satisfy a first threshold value.

At operation 260, in response to determining the variations do not satisfy a first threshold value, the processing logic transmits, in a feedback packet to the anchor wireless device, an indication that there are no CSI-based changes to the wireless channel. Thus, when the CSI-based changes are sufficiently minor (e.g., below the first threshold value), the response can be a no-change indicator.

At operation 265, in response to, at operation 255, the variations in the latent vectors satisfying the first threshold value, the processing logic determines whether the variations in the latent vectors satisfy a second threshold value that is larger than the first threshold value.

At operation 270, in response to the variations satisfying the first threshold value (at operation 255) but not the second threshold value, the processing logic transmits the packet, to the anchor wireless device 102, containing a delta latent vector that encodes the variations.

At operation 275, in response to the variations in the latent vectors satisfying, at operation 265, the second threshold value, the processing logic transmits, to the anchor wireless device 102, the packet containing an updated latent vector that completely characterizes CSI of the wireless channel.

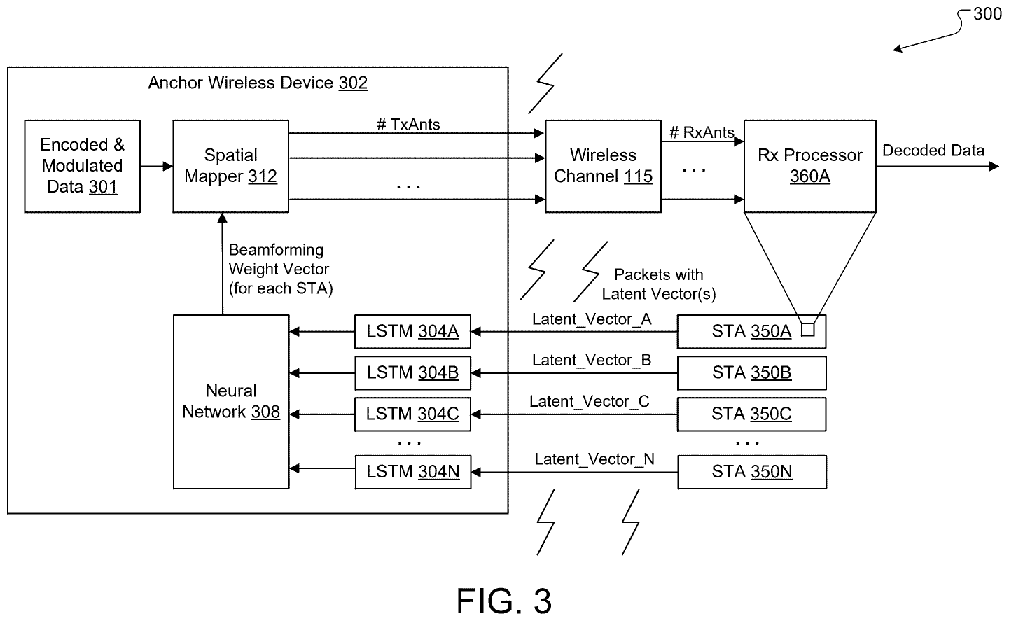

FIG. 3 is a block diagram of a wireless network 300 that includes an example anchor wireless device 302 that performs deep learning, using the latent vectors, for scalable transmission beamforming with compressed channel representation according to various embodiments. In some embodiments, the anchor wireless device 302 is the anchor wireless device 102 of FIG. 1 and FIGS. 2A-2B. In various embodiments, the wireless network 300 includes a plurality of STAs 350A, 350B, 350C, . . . 350N, that communicate their respective latent vectors (e.g., latent_vector_A, latent_vector_B, latent_vector_C, . . . latent_vector_N, respectively) to the anchor wireless device 302. In embodiments, each STA is configured as the STA 150 described with reference to FIG. 1.

In some embodiments, the anchor wireless device 302 includes a plurality of LSTM networks 304A, 304B, 304C, . . . 304N that process the respective latent vectors received from the plurality of STAs 350A-350N. The anchor wireless device 302 can utilize a trained LSTM network for each STA to track, predict, and update the CSI data for a respective STA over time based on the feedback received from the respective STA. In quasi-static scenarios, e.g., wireless channels with slow variations, the anchor wireless device can leverage the predictions of each LSTM network to avoid unnecessary periodic feedback overhead.

In some embodiments, the anchor wireless device 302 further includes a neural network 308 that receives the latent vectors from the plurality of STAs 350A-350N (or updated latent vectors from the LSTM networks 304A-304N based on tracked variations to the latent vectors) and outputs a beamforming weight vector for each STA. For example, each beamforming weight vector can be directed at a particular STA. For purposes of explanation only, the particular STA in FIG. 3 is illustrated as the STA 350A. In embodiments, a spatial mapper 312 of the anchor wireless device 302 directly integrates the beamforming weight vector for the particular STA within spatial mapping when transmitting encoded and modulated data 301 to the particular STA. The spatial mapping defined by the beamforming weight vector, which was output by the neural network 308, directs transmission packets over the wireless channel 115 to the particular STA 350A. In embodiments, a receiving (Rx) processor 360A of the STA 350A parses and decodes the data 301, thus outputting the decoded data for handling by the STA 350A.

In this way, instead of decoding the latent representation back into the V matrix (as in previous descriptions), the anchor wireless device 302 directly maps the latent representations (e.g., latent vectors) from active STAs to a corresponding beamforming weight vector for each individual STA of the plurality of STAs 350A-350N. This eliminates the need for separate decoding and beamforming mapping stages, simplifying the process and improving efficiency.

In some embodiments, each STA(i) transmits a compressed latent representation (z_i) of its CSI data obtained through a deep learning model (e.g., a stand-alone encoder or an autoencoder followed by an LSTM network). In embodiments, the anchor wireless device 302 seeks to compute the beamforming weight vectors (w_i) for STA(i) at the anchor wireless device 302, bypassing the traditional V matrix reconstruction.

For example, in some embodiments, the neural network 308 is a fully connected neural network (FCNN). In embodiments, the anchor wireless device 302 concatenates the latent vectors (z_1, z_2, z_3, . . . , z_N) from N active STAs into a single latent vector (z). The FCNN can include multiple hidden layers that take the vector z as input and outputs the beamforming weight vector (w_i) for the desired STA(i). In this way, he beamforming weight vector can be expressed as w_i=FCNN([z_1, z_2, . . . , z_N]).

In other embodiments, the neural network 308 is a multi-layer perceptron neural network (or MLP NN) that employs STA embedding. For example, the anchor wireless device 302 can assign each STA a unique embedding vector (e_i) learned during the training process associated with the neural network 308. In embodiments, the anchor wireless device 302 concatenates the STA embedding (e_i) with the latent representation (z_i) for STA(i). The MLP NN can employ multiple hidden layers to process the concatenated vector (e_i, z_i) and output the beamforming weight vector (w_i). Thus, the beamforming weight vector can be expressed as w_i=MLP([e_i, z_i]).

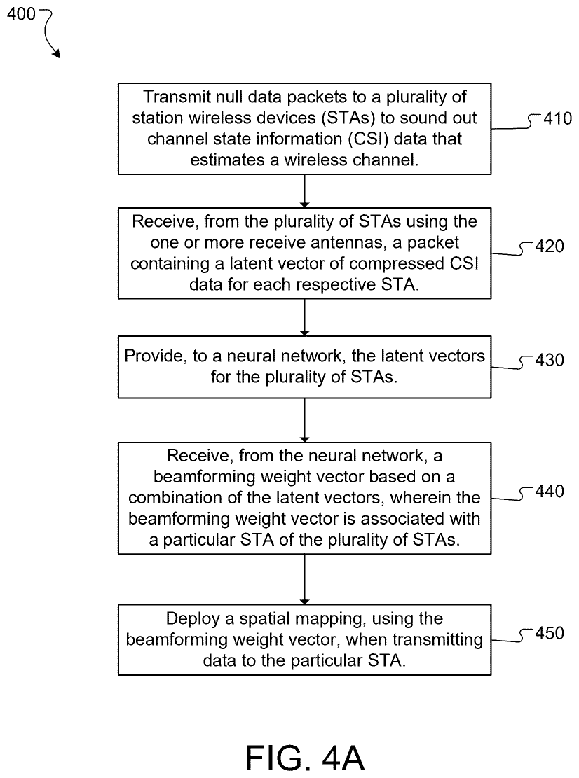

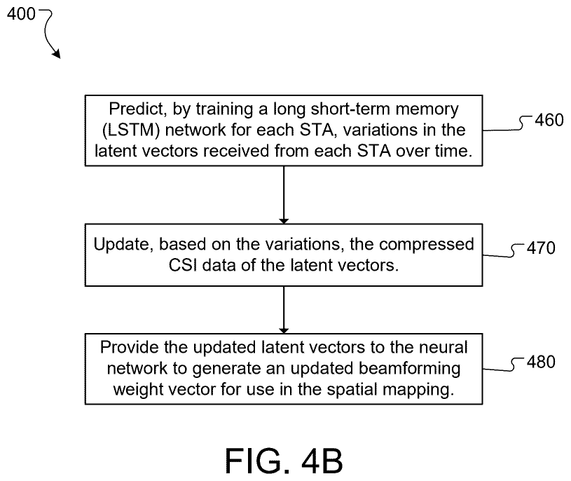

FIG. 4A is a flow chart of a method 400 for the anchor wireless device 102 employing a neural network to combine latent vectors into beamforming weight vectors according to some embodiments. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the anchor wireless device 102 for example. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic transmits, using the one or more transmit antennas, null data packets to a plurality of station wireless devices (STAs) to sound out channel state information (CSI) data that estimates a wireless channel.

At operation 420, the processing logic receives, from the plurality of STAs using the one or more receive antennas, a packet containing a latent vector of compressed CSI data for each respective STA.

At operation 430, the processing logic provides, to the neural network 308, the latent vectors for the plurality of STAs.

At operation 440, the processing logic receives, from the neural network 308, a beamforming weight vector based on a combination of the latent vectors. In embodiments, the beamforming weight vector is associated with a particular STA of the plurality of STAs, e.g., the STA 350A. Different possible neural networks that may be employed was discussed with reference to FIG. 3.

At operation 450, the processing logic deploys a spatial mapping, using the beamforming weight vector, when transmitting data to the particular STA using the one or more transmit antennas.

FIG. 4B is a flow chart of the method 400 of FIG. 4A in which the anchor wireless device also predicts, using a LSTM network for each STA, variations in the latent vectors over time according to some embodiments. At operation 460, the processing logic predicts, by training a long short-term memory (LSTM) network for each STA, variations in the latent vectors received from each STA over time. At operation 470, the processing logic updates, based on the variations, the compressed CSI data of the latent vectors. At operation 480, the processing logic provides the updated latent vectors to the neural network to generate an updated beamforming weight vector for use in the spatial mapping, as was discussed in relation to FIG. 3. In some embodiments, each of at least some of the latent vectors received from the plurality of STAs 350A-350N is a delta latent vector that encodes the variations in a trained second LSTM located at each respective STA.

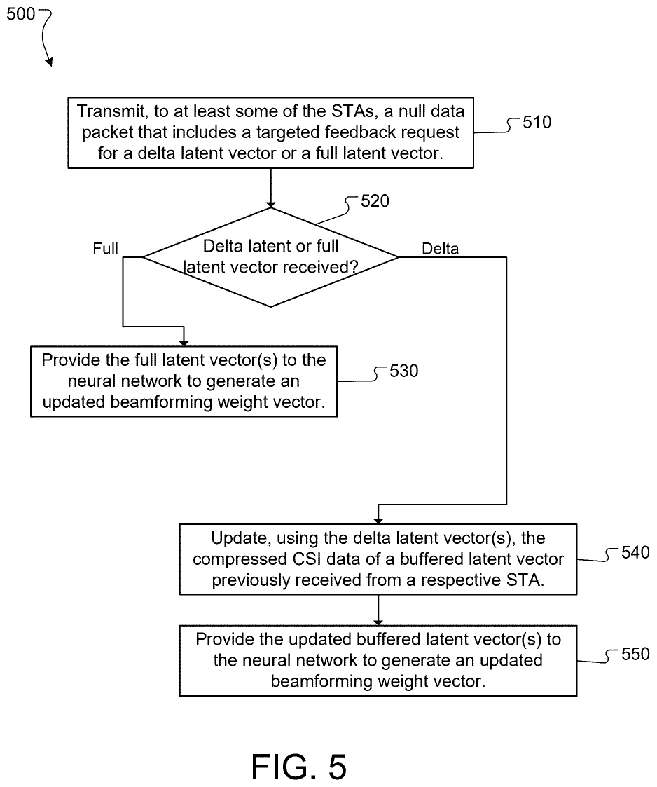

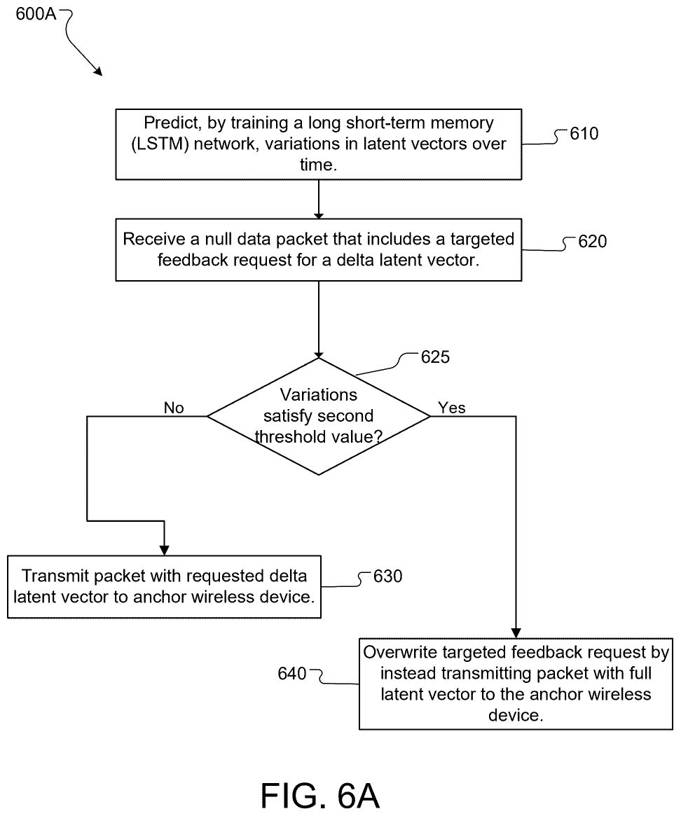

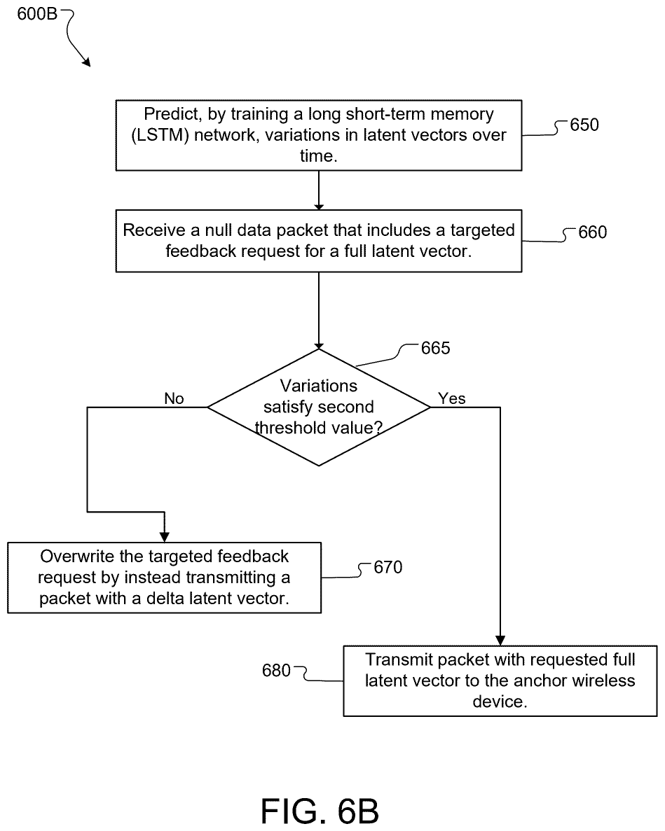

With additional reference to FIG. 3, in some embodiments, the anchor wireless device 302 transmits a null data packet (NDP) frame to the STA 350A that includes a request for a specific type of feedback (e.g., delta change or complete CSI latent vector). This targeted request mechanism allows the anchor wireless device 302 to efficiently gather the required CSI information from the plurality of STAs 350A-350N when needed for dynamic beamforming adjustments. At each STA, the received feedback request from the anchor wireless device 302 can be compared with a current prediction of the STA based on states of its LSTM network. If the similarity metric like mean squared error (MSE) between the predicted and requested CSI data exceeds a threshold value, the STA can overwrite the feedback request and transmit the complete latest CSI-based latent vector. In this way, the anchor wireless device 302 can receive the most accurate data when channel changes are rapid or unpredictable. FIG. 5 and FIGS. 6A-6B describe various embodiments of this NDP frame-based request and how STAs can handle the request.

FIG. 5 is a flow chart of a method 500 for the anchor wireless device directing a targeted feedback request to the STAs to request particular latent vectors in order to update the beamforming weight vectors being used according to some embodiments. The method 500 can be performed by processing logic that can include hardware (e.g., processing device, circuitry, dedicated logic, programmable logics, microcode, hardware of a device, integrated circuit, etc.), software (e.g., instructions run or executed on a processing device), or a combination thereof. In some embodiments, the method 500 is performed by the anchor wireless device 302 for example. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic transmits, to at least some of the plurality of STAs, a null data packet that includes a targeted feedback request for a delta latent vector or a full vector. The anchor wireless device 302 can then receive, from each of the targeted STAs 350A-350N, the one of the delta latent vector or the full latent vector.

For example, at operation 520, the processing logic determines whether a delta latent vector or a full latent vector is received from each STA of the plurality of STAs 350A-350N in response to the NDP-based request. In embodiments, the full latent vector completely characterizes compressed CSI of the wireless channel 115.

At operation 530, in response to receiving a full latent vector, the processing logic provides the full latent vector to the neural network 308 to generate an updated beamforming weight vector for the particular STA 350A and optionally also for other active STAs of the plurality of STAs 350A-350N. In embodiments, the updated beamforming weight vector can be based on multiple full latent vectors received from multiple active STAs of the plurality of STAs.

At operation 540, in response to receiving a delta latent vector, the processing logic updates, using the delta latent vector, the compressed CSI data of a buffered latent vector previously received from a respective STA.

At operation 550, the processing logic provides the updated buffered latent vector to the neural network 308 to generate the updated beamforming weight vector for the particular STA 350A and optionally also for other active STAs of the plurality of STAs 350A-350N. For example, in some embodiments, the updated beamforming weight vector can be based on multiple delta latent vectors received from multiple active STAs of the plurality of STAs.

FIG. 6A is a flow chart of a method 600A for a STA handling of the targeted feedback request according to at least one embodiment. The method 600A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600A is performed by the STA 350A for example. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic predicts, by training a long short-term memory (LSTM) network, variations in latent vectors over time, which was also discussed in relation to FIG. 2B.

At operation 620, the processing logic receives a null data packet that includes a targeted feedback request for a delta latent vector.

At operation 625, the processing logic determines whether the variations in latent vectors satisfy the second threshold value, which is larger than the first threshold value, as referenced previously.

At operation 630, the processing logic, in response to the variation not satisfying the second threshold value, transmits a packet with the requested delta latent vector to the anchor wireless device.

At operation 640, the processing logic, in response to the variations satisfying the second threshold value, overwrites the targeted feedback request by instead transmitting the packet with a full latent vector to the anchor wireless device.

FIG. 6B is a flow chart of a method for a STA handling of the targeted feedback request according to at least another embodiment. The method 600A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600A is performed by the STA 350A for example. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic predicts, by training a long short-term memory (LSTM) network, variations in latent vectors over time, which was also discussed in relation to FIG. 2B.

At operation 620, the processing logic receives a null data packet that includes a targeted feedback request for a full latent vector.

At operation 665, the processing logic determines whether the variations in latent vectors satisfy the second threshold value, which is larger than the first threshold value, as referenced previously.

At operation 670, the processing logic, in response to the variation not satisfying the second threshold value, overwrites the targeted feedback request by instead transmitting a packet with a delta latent vector.

At operation 680, the processing logic, in response to the variations satisfying the second threshold value, transmitting the packet with the requested full latent vector to the anchor wireless device.

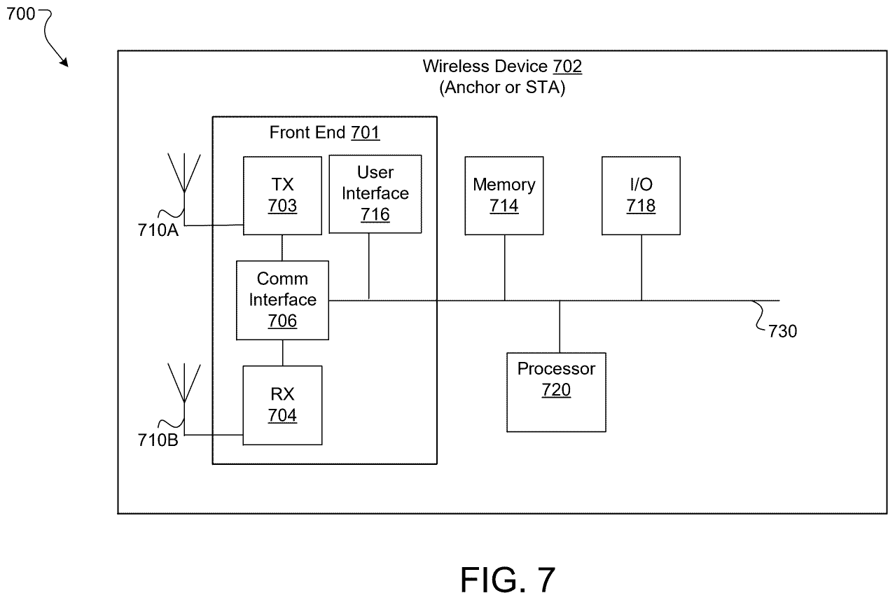

FIG. 7 is an example wireless device 700 that can represent any of the anchor wireless devices or station wireless device (STAs) capable of performing the operations discussed herein according to embodiments. For example, the client wireless devices may include the AMP device 120. In at least some embodiments, the wireless device 700 includes, but is not be limited to, a transmitter 702 or TX (e.g., a WLAN transmitter), a receiver 704 or RX (e.g., a WLAN receiver), a communications interface 706, at least one TX antenna 710A coupled to the transmitter 702, at least one RX antenna 710B coupled to the receiver 704, a memory 714, one or more input/output (I/O) devices 718 (such as a display screen, a touch screen, a keypad, and the like), a processor 720, an AMP collection circuit 725, and energy cells 728. In embodiments, the wireless device 700 includes two antennas for multiple input, multiple output (MIMO) operation of a transceiver (e.g., including the TX and RX), which may include switching circuitry to switch between dual bands, including for example, the 2.4 GHz and 5 GHz bands.

These components can all be coupled to a communications bus 730 or multiple communication buses. In some embodiments, at least some of the components of the wireless device 700 are directly connected and may thus not be coupled through the communication bus 730. Thus, illustration of the communication bus 730 is not to be taken as required or limiting for at least some of the components of the wireless device 700, which may directly intercommunicate.

In some embodiments, aspects of the communication interface 706 work with the processor 720 to perform operations or that function as a processing device of the wireless device 700. In some embodiments, there is a single antenna and multiplexing logic to switch use of the antenna between the TX and RX.

In at least some embodiments, the memory 714 includes storage to store instructions executable by the processor 720 and/or data generated by the communication interface 706. In various embodiments, frontend components such as the transmitter 702, the receiver 704, the communication interface 706, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-wave™, Zigbee®, LoRa™, Wireless Smart Utility Network® (Wi-SUN®), or other wireless protocol. While some of the protocols may also be referred to as personal area network (PAN) technology, for simplicity, all are broadly referred to as WLAN technology. Future protocols are also envisioned.

In various embodiments, the communications interface 706 is integrated with the transmitter 702 and the receiver 704, e.g., as a frontend of the wireless device 700. The communication interface 706 may coordinate, as directed by the processor 720, to request/receive packets from other wireless devices or those that reflect off objects. The communications interface 706 can further process data symbols received by the receiver 704 in a way that the processor 720 can perform further processing, including identifying and parsing data packets received within the wireless signals. In some embodiments, the transmitter 702, receiver 704, communication interface 706, and antennas 710A and 710B can be referred to herein as a “wireless communication circuit.”

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for deep learning herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A wireless device comprising:
one or more receive antennas;
a processing device coupled to the one or more receive antennas; and
memory storing instructions, which when executed by the processing device, cause the processing device to perform operations comprising:
generating, in response to a null data packet received from an anchor wireless device, channel state information (CSI) data to estimate a wireless channel;
processing the CSI data using an encoder neural network to generate a latent vector of compressed CSI data; and
transmitting, via a coupled transmit antenna, a packet containing the latent vector to the anchor wireless device for use in determining beamforming to communicate with the wireless device and detect changes in the wireless channel.

2. The wireless device of claim 1, wherein the encoder neural network is an autoencoder that reduces dimensionality of the CSI data while capturing CSI characteristics to be used for the beamforming, wherein the dimensionality comprises a number of subcarriers of the wireless channel, a number of transmit antennas of the anchor wireless device, and a number of the one or more receive antennas.

3. The wireless device of claim 1, wherein the operations further comprise:
predicting, by training a long short-term memory (LSTM) network, variations in latent vectors over time; and
in response to determining the variations do not satisfy a first threshold value, transmitting, in a feedback packet to the anchor wireless device, an indication that there are no CSI-based changes to the wireless channel.

4. The wireless device of claim 1, wherein the operations further comprise:
predicting, by training a long short-term memory (LSTM) network, variations in latent vectors over time; and
in response to determining the variations satisfy a first threshold value, transmitting the packet to the anchor wireless device containing a delta latent vector that encodes the variations.

5. The wireless device of claim 4, wherein the operations further comprise:
determining the variations satisfy a second threshold value that is greater than the first threshold value; and
transmitting, to the anchor wireless device, the packet containing an updated latent vector that completely characterizes CSI of the wireless channel.

6. The wireless device of claim 4, wherein the operations further comprise:
receiving a second null data packet that includes a targeted feedback request for one of the delta latent vector or a full latent vector, wherein the full latent vector completely characterizes compressed CSI of the wireless channel; and
transmitting, in response to the targeted feedback request, to the anchor wireless device, a second packet with the one of the delta latent vector or the full latent vector.

7. The wireless device of claim 6, wherein the targeted feedback request is for the delta latent vector, and wherein the operations further comprise:
determining the variations satisfy a second threshold value that is greater than the first threshold value; and
instead transmitting the full latent vector to the anchor wireless device.

8. An anchor wireless device comprising:
one or more transmit antennas;
one or more receive antennas;
a processing device coupled to the one or more transmit and receive antennas; and
memory storing instructions, which when executed by the processing device, cause the processing device to perform operations comprising:
transmitting, using the one or more transmit antennas, null data packets to a plurality of station wireless devices (STAs) to sound out channel state information (CSI) data that estimates a wireless channel;
receiving, from the plurality of STAs using the one or more receive antennas, a packet containing a latent vector of compressed CSI data for each respective STA;
providing, to a neural network, the latent vectors for the plurality of STAs;
receiving, from the neural network, a beamforming weight vector based on a combination of the latent vectors, wherein the beamforming weight vector is associated with a particular STA of the plurality of STAs; and
deploying a spatial mapping, using the beamforming weight vector, when transmitting data to the particular STA using the one or more transmit antennas.

9. The anchor wireless device of claim 8, wherein the neural network is one of a fully connected neural network or a multi-layer perceptron neural network.

10. The anchor wireless device of claim 8, wherein the operations further comprise:
predicting, by training a long short-term memory (LSTM) network for each STA, variations in the latent vectors received from each STA over time;
updating, based on the variations, the compressed CSI data of the latent vectors; and
providing the updated latent vectors to the neural network to generate an updated beamforming weight vector for use in the spatial mapping.

11. The anchor wireless device of claim 10, wherein each of at least some of the latent vectors received from the plurality of STAs is a delta latent vector that encodes the variations in a trained second LSTM located at each respective STA.

12. The anchor wireless device of claim 8, wherein the operations further comprise:
transmitting, to at least some of the plurality of STAs, a second null data packet that includes a targeted feedback request for one of a delta latent vector or a full latent vector, wherein the full latent vector completely characterizes compressed CSI of the wireless channel; and
receiving, from the at least some of the plurality of STAs, the one of the delta latent vector or the full latent vector.

13. The anchor wireless device of claim 12, wherein the operations further comprise, in response to receiving a full latent vector, providing the full latent vector to the neural network to generate an updated beamforming weight vector for the particular STA.

14. The anchor wireless device of claim 12, wherein the operations further comprise, in response to receiving a delta latent vector:
updating, using the delta latent vector, the compressed CSI data of a buffered latent vector previously received from a respective STA; and
providing the updated buffered latent vector to the neural network to generate an updated beamforming weight vector for the particular STA.

15. A method comprising:
generating, by a wireless device, in response to a null data packet received from an anchor wireless device, channel state information (CSI) data to estimate a wireless channel;
processing the CSI data using an encoder neural network to generate a latent vector of compressed CSI data; and
transmitting, via a coupled transmit antenna of the wireless device, a packet containing the latent vector to the anchor wireless device for use in determining beamforming to communicate with the wireless device and detect changes in the wireless channel.

16. The method of claim 15, further comprising:
predicting, by training a long short-term memory (LSTM) network, variations in latent vectors over time; and
in response to determining the variations do not satisfy a first threshold value, transmitting, in a feedback packet to the anchor wireless device, an indication that there are no CSI-based changes to the wireless channel.

17. The method of claim 15, further comprising:
predicting, by training a long short-term memory (LSTM) network, variations in latent vectors over time; and
in response to determining the variations satisfy a first threshold value, transmitting the packet to the anchor wireless device containing a delta latent vector that encodes the variations.

18. The method of claim 17, further comprising:
determining the variations satisfy a second threshold value that is greater than the first threshold value; and
transmitting, to the anchor wireless device, the packet containing an updated latent vector that completely characterizes CSI of the wireless channel.

19. The method of claim 17, further comprising:
receiving a second null data packet that includes a targeted feedback request for one of the delta latent vector or a full latent vector, wherein the full latent vector completely characterizes compressed CSI of the wireless channel; and
transmitting, to the anchor wireless device, a second packet with the one of the delta latent vector or the full latent vector.

20. The method of claim 19, wherein the targeted feedback request is for the full latent vector, the method further comprising:
determining the variations do not satisfy a second threshold value that is greater than the first threshold value; and
instead transmitting the delta latent vector to the anchor wireless device.
